(19) United States
(12) Patent Application Publication
(10) Pub. No.: US 2010/0198577 A1
(43) Pub. Date: Aug. 5, 2010

(54) STATE MAPPING FOR CROSS-LANGUAGE SPEAKER ADAPTATION

(75) Inventors: Yi-Ning Chen, Beijing (CN); Yao Qian, Beijing (CN); Frank Kao-Ping Soong, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corporation, Remond, WA (US)

(21) Appl. No.: 12/365,107

(22) Filed: Feb. 3, 2009

(51) Int. Cl. G06F 17/28

(52) U.S. Cl. 704/2; 704/E13.002

(57) ABSTRACT

Creation of sub-phonemic Hidden Markov Model (HMM) states and the mapping of those states results in improved cross-language speaker adaptation. The smaller sub-phonemic mapping provides improvements in usability and intelligibility particularly between languages with few common phonemes. HMM states of different languages may be mapped to one another using a distance between the HMM states in acoustic space. This distance may be calculated using Kullback-Leibler divergence and multi-space probability distribution. By combining distance mapping and context mapping for different speakers of the same language improved cross-language speaker adaptation is possible.

### BACKGROUND

Human speech is a powerful communication medium, and the distinct characteristics of a particular speaker's voice act at the very least to identify the speaker to others. When translating speech from one language to another, it would be desirable to produce output speech which sounds like speech originating from the human speaker. In other words, a translation of your voice ideally would sound like your voice speaking the language. This is termed translation with cross-language speaker adaptation.

Speaker adaptation involves adapting (or modifying) the voice of one speaker to produce output speech which sounds similar or identical to the voice of another speaker. Speaker adaptation has many uses, including creation of customized voice fonts without having to sample and build an entirely new model, which is an expensive and time-consuming process. This is possible by taking a relatively small number of samples of an input voice and modifying an existing voice model to conform to the characteristics of the input voice.

However, cross-language speaker adaptation experiences several complications, particularly when based on phonemes. Phonemes are acoustic structural units that distinguish meaning, for example the /t/ sound in the word “tip.” Phonemes may differ widely between languages, making cross-language speaker adaptation difficult. For example, phonemes which appear in tonal languages such as Chinese may have no counterpart phonemes in English, and vice versa. Thus, phoneme mapping is inadequate, and a better method of cross-language speaker adaptation is desirable.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Sub-phonemic samples are used to train states in a Hidden Markov Model (HMM), where each HMM state represents a distinctive sub-phonemic acoustic-phonetic event in a spoken language. Use of sub-phonemic HMM states improves mapping of these states between different languages compared to phoneme mapping alone. Thus, a greater number of sub-phonemic HMM states may be common between languages, compared to larger phoneme units. Speaker adaptation modifies (or adapts) HMM states of an HMM model based on sampled input. During speaker adaptation, the increase in commonality resulting from using sub-phonemic HMM states improves intelligibility and results in a more natural sounding output that more closely resembles the source speaker.

Distortion measure mapping, which includes distance-based mapping, may take place between HMM states in a first HMM model representing a first language and HMM states in a second HMM model representing a second language. A distance between the HMM states in acoustic space may be determined using Kullback-Leibler Divergence with multi-space probability distribution (“KLD”), or other distances such as Euclidean distance, Mahalanobis distance, etc. HMM states from the first and second HMM models having a minimum distance to one-another in the acoustic space (that is, they are spatially “close”) may then be mapped to one another.

Where HMM models are between different voices in the same language, context mapping may be used. Context mapping comprises mapping one leaf of an HMM model tree of one voice to a corresponding leaf of an HMM model tree of another voice.

Cross-language speaker adaptation may thus take place using a combination of context and KLD mappings between HMM states, thus providing a bridge from an original speaker uttering the speaker's language to a synthesized output voice speaking a listener's language, with the output voice resembling that of the original speaker.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of speaker adaptation in an illustrative translation environment.

FIG. 2 is an illustrative breakdown of words from two languages into sub-phoneme samples.

FIG. 3 is a flow diagram illustrating building a Hidden Markov Model (HMM) state from sub-phoneme samples.

FIG. 4 is a flow diagram illustrating speaker adaptation in a same language.

FIG. 5 is a schematic showing a similarity of phonemes between source and listener languages.

FIG. 6 is a schematic showing a similarity of HMM states (sub-phonemes) between source and listener languages.

FIG. 7 is an illustration of HMM models for words in two different languages.

FIG. 8 is an illustration of mapping between the HMM states of the HMM models of FIG. 7 in acoustic space using KLD.

FIG. 9 is an illustration of KLD mapping between the HMM states of the HMM models of FIG. 7 showing the HMM model trees.

FIG. 10 is an illustration of context mapping between HMM states.

FIG. 11 is an illustrative schematic of a speech-to-speech translation computer system using speaker adaptation.

FIG. 12 is a flow diagram of an illustrative process of creating state mappings for cross-language speaker adaptation.

FIG. 13 is flow diagram of an illustrative process of state mapping for cross-language speaker adaptation.

FIG. 14 is flow diagram of an illustrative process of context mapping between HMM states.

FIG. 15 is flow diagram of an illustrative process of KLD mapping between HMM states.

### DETAILED DESCRIPTION

### Overview

As described above, phoneme mapping for cross-language speaker adaptation results in less than desirable results where the languages have significantly different phonemes.

This disclosure describes using sub-phonemic HMM state mapping for cross-language speaker adaptations. Sub-phonemic samples are used to train states in a Hidden Markov Model (HMM), where each HMM state represents a distinctive sub-phonemic acoustic-phonetic event in a spoken language. Use of sub-phonemic HMM states improves mapping of these states between different languages compared to phoneme mapping alone. Thus, a greater number of sub-phonemic HMM states may be common between languages, compared to larger phoneme units. Speaker adaptation modifies (or adapts) HMM states of an HMM model based on sampled input. During speaker adaptation, the increase in commonality resulting from using sub-phonemic HMM states improves intelligibility and results in a more natural sounding output that more closely resembles the source speaker.

Where HMM models are of different languages, distance-based mapping may take place between HMM states in the HMM models of the differing languages. A distance between the HMM states in acoustic space may be determined using Kullback-Leibler Divergence with multi-space probability distribution (“KLD”), Euclidean distance, Mahalanobis distance, etc. HMM states from the first and second HMM models having a minimum distance to one-another in the acoustic space (that is, they are spatially “close”) may then be mapped to one another.

Where HMM models are between different voices in the same language, context mapping may be used. Context mapping comprises mapping one leaf of an HMM model tree of one voice to a corresponding leaf of an HMM model tree of another voice.

Cross-language speaker adaptation may thus take place using a combination of context and KLD mappings between HMM states, thus providing a bridge from an original speaker uttering the speaker's language to an output voice speaking a listener's language, with the output voice resembling that of the original speaker.

For example, a voice of a speaker speaking in the language of the speaker VSLS) may be sampled, and the samples mapped using context mapping to the voice of an auxiliary speaker speaking LS (VALS). KLD mapping may then be used to map VALS to same voice of the auxiliary speaker speaking a language of the listener (VALL). Context mapping maps VALL to a voice of the listener speaking the language of the listener (VLLL). The VLLL model may then be modified, or adapted, using the samples from VSLS to form the voice of the output in the language of the listener (VOLL).

### Speaker Adaptation

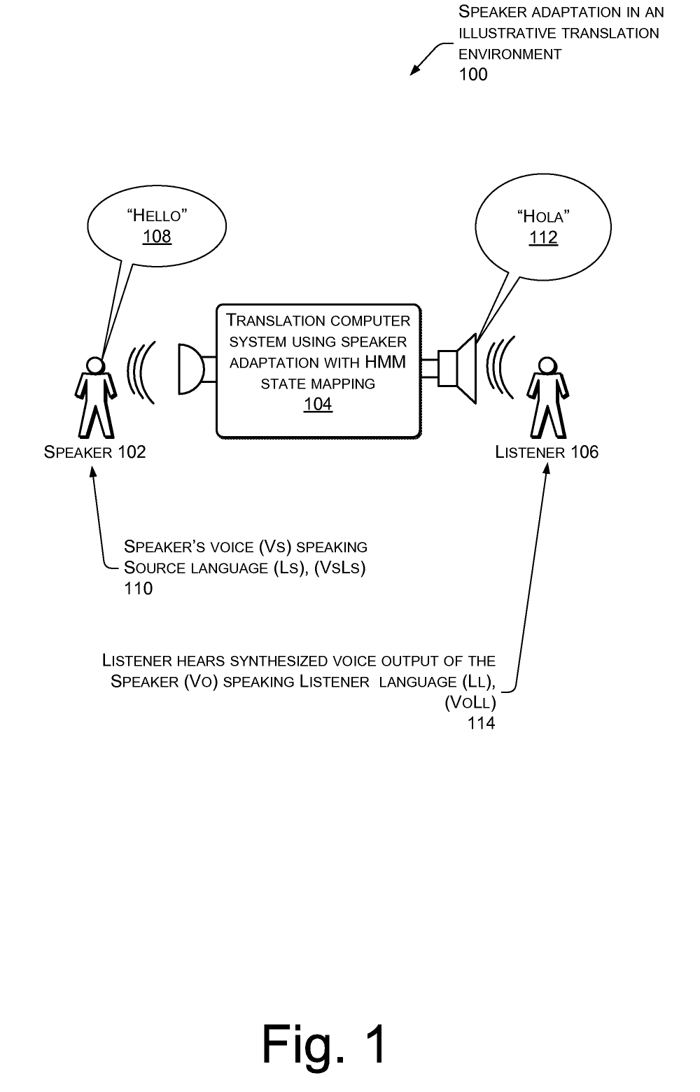

FIG. 1 is a schematic diagram of speaker adaptation in an illustrative translation environment 100. A human speaker 102, or a recording or device reproducing human speech, is shown with a translation computer system using speaker adaptation with HMM state mapping 104 and a listener 106. Human speaker 102 produces speech 108 saying the word “Hello.” The speaker's voice speaking the language of the speaker (LS) (in this example, English) (VSLS) 110 is input into the translation computer system 104 via an input device, such as the microphone depicted here. After processing in the translation computer system 104, the translated word “Hola” is output 112 in Listener language LL, Spanish in this example. This output 112 is presented to listener 106 via an output device, such as the speaker depicted here. The output comprises synthesized voice output of the human speaker 102 uttering the listener's 106 language (VOLL). Thus, the listener 106 appears to hear the speaker 102 speaking the listener's language.

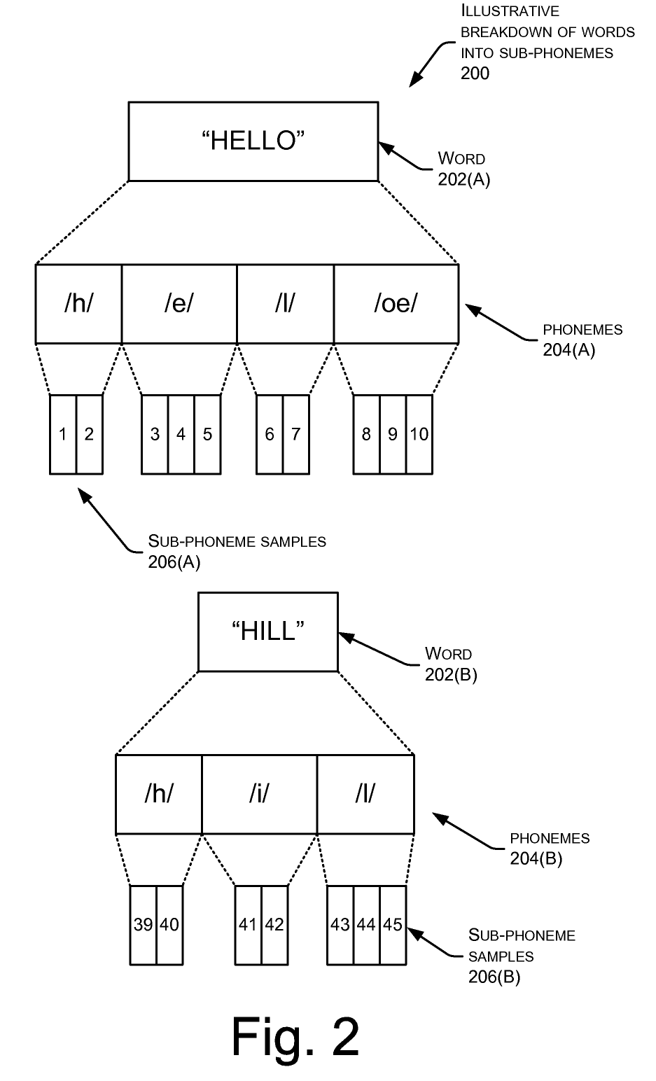

FIG. 2 is an illustrative breakdown of words from two languages into sub-phoneme samples 200. A word, for example “hello” 202(A) is shown broken into phonemes /h/, /e/, /l/, and /oe/ 204(A). As described earlier, phonemes are acoustic structural units that distinguish meaning. The /t/ sound in the word “tip” is a phoneme, because if the /t/ sound is replaced with a different sound, for example /h/, the meaning of the word would change.

Phonemes 204(A) may be further broken down into sub-phonemes 206(A). For example, the phoneme /h/ may decompose into two sub-phonemes (labeled 1-2) while the phoneme /e/ may decompose into three sub-phonemes (labeled 3-5).

A second word “hill” 202(B) is shown with phonemes /h/ /i/ /l/ 204(B) and sub-phoneme samples 206(B). As with 204(A) and 206(A) describe above, phoneme /h/ in phonemes 204(B) may decompose into two sub-phonemes 206(B), labeled 39-40.

Phonemes may be broken down in a variable number of sub-phonemes, as described above, or as a specified number of sub-phonemes. For example, each phoneme may be broken down into 1, 2, 3, 4, 5, etc. sub-phonemes. Phonemes may comprise context dependent phones, that is, speech sounds where a relative position with other phones results in different speech sounds. For example, if phones “c ae t” of word “cat” are present, “c” is the left phone of “ae,” and “t” is the right phone of “ae.”

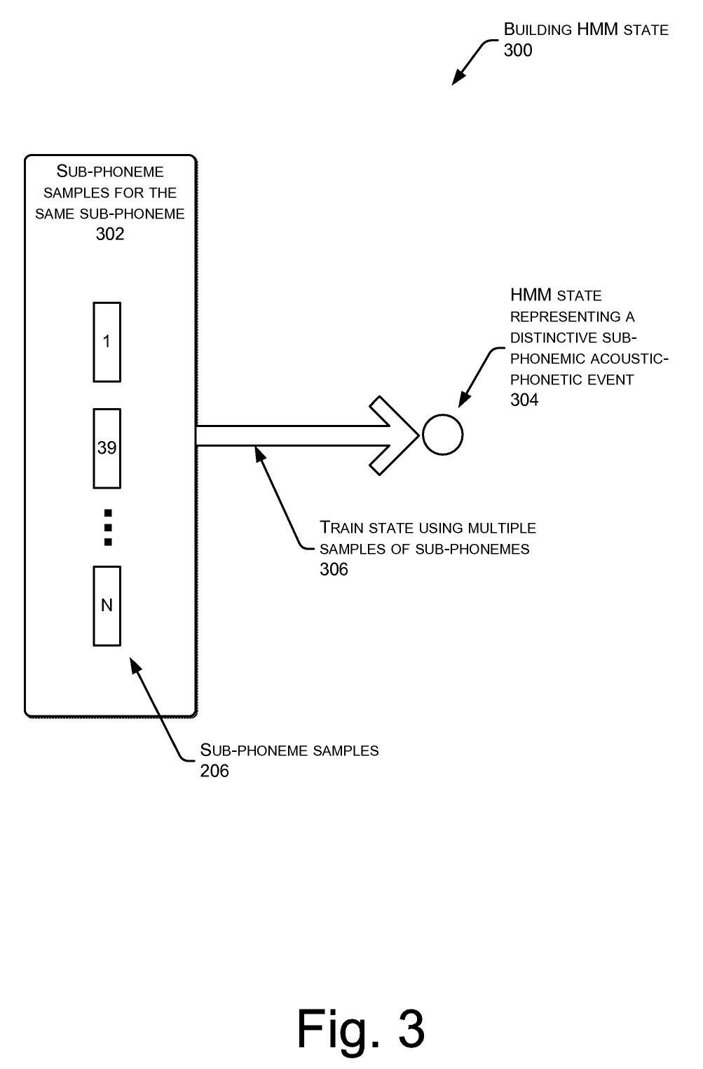

FIG. 3 is a flow diagram illustrating the building of an HMM state from sub-phoneme samples 300. At 302 sub-phoneme samples of the same sub-phoneme are grouped. For example, the sub-phonemes 1 and 39 from sub-phoneme samples 206 shown in FIG. 2 along with other sub-phonemes (designed “N” in this diagram) representing the first sub-phoneme of the /h/ phoneme may be grouped together. At 304, an HMM state representing a distinctive acoustic-phonetic event is built. At 306, the state is trained using multiple sub-phoneme samples.

Individual HMM states may then be combined to form an HMM model. This application describes the HMM model as a tree with each leaf being a discrete HMM state. However, other models are possible.

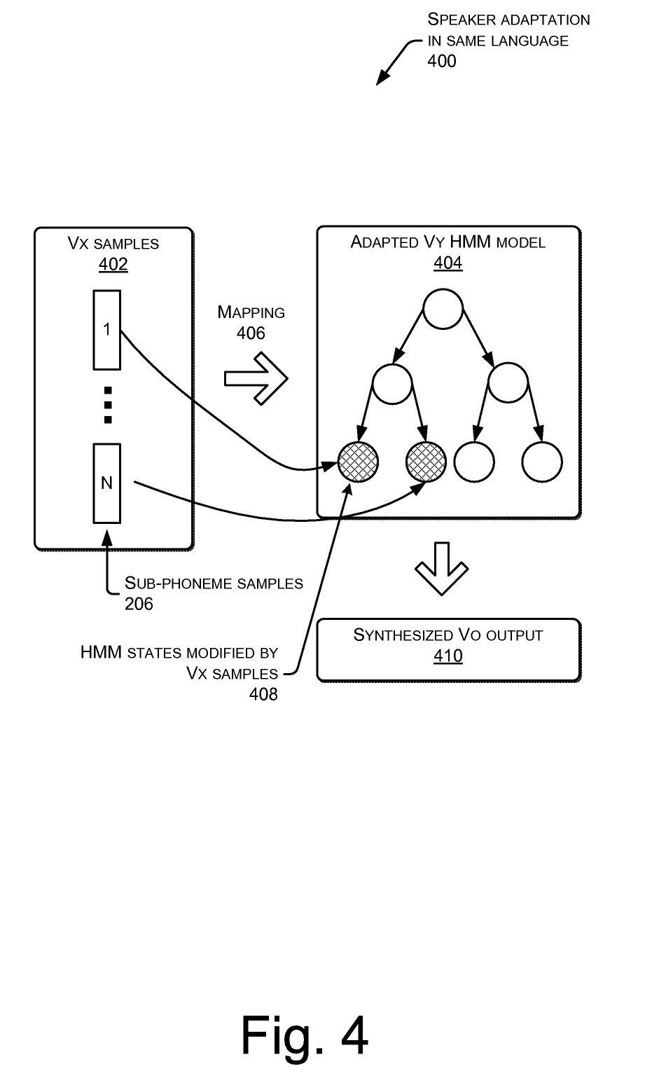

FIG. 4 is a flow diagram illustrating speaker adaptation in a same language 400. At 402, sub-phonemic samples 206 as described above of a first voice, voice “X” or VX, are taken. At 404, an HMM model of a second voice “Y” or VY is adapted at 406 by mapping the VX samples to corresponding leaves of the VY HMM model. The VX samples thus modify the VY states. At 410, a synthesized voice VO output may be generated.

As described earlier, speaker adaptation has many uses. For example, customized voice fonts may be created without having to sample and build an entirely new HMM model. This is possibly by taking a relatively small number of samples of an input voice (VX) and modifying an existing voice model (VY) to conform to the characteristics of the input voice (VX). Thus, synthesized output Vo 410 generated from the adapted Vy HMM model 404 sounds as though spoken by voice X.

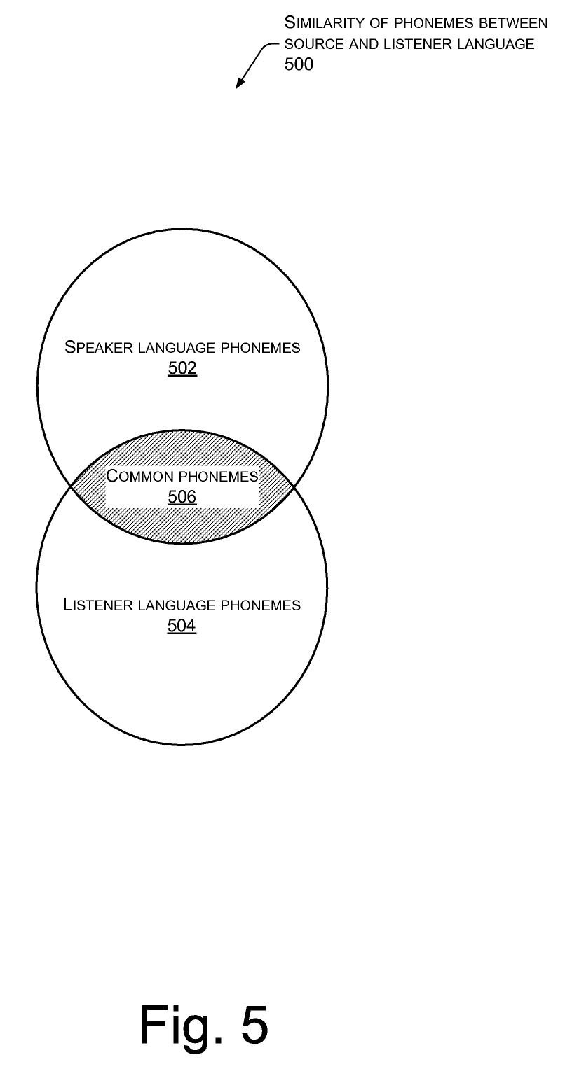

FIG. 5 is a schematic showing a similarity of phonemes between source and listener languages 500. In the relatively simple case of the same language described in FIG. 4, the phonemes are essentially the same or identical because X and Y are speaking the same language. However, as depicted in FIG. 5, speaker language phonemes 502 when compared to listener language phonemes 504 may only have a limited subset of common phonemes 506. This situation worsens when languages differ greatly. For example, the overlap of phonemes between tonal languages such as Chinese and non-tonal languages is small compared to the overlap of phonemes between languages with similar roots, for example English and Spanish. Traditional cross-language speaker adaptation systems using phonemes as their elemental units may thus produce poor mappings.

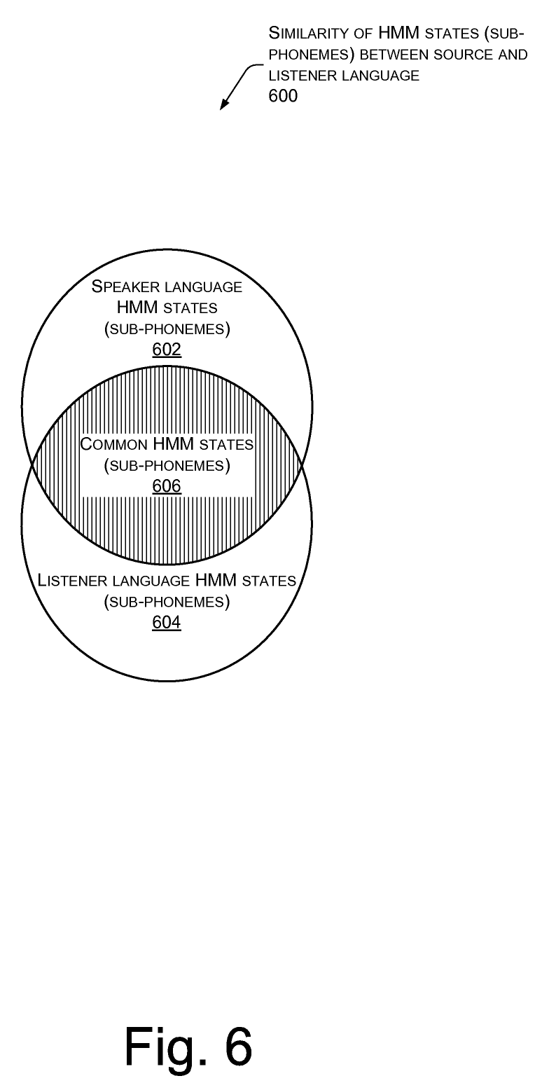

FIG. 6 is a schematic showing a similarity of HMM states (sub-phonemes) between source and listener languages 600. By using the smaller sub-phonemes described in FIG. 2, more overlap is possible. For example, the sub-phonemes or HMM states of a speaker's language 602 and the sub-phonemes or HMM states of a listener's language 604 may have a greater overlap of common sub-phonemes or HMM states. This greater degree of overlap allows more use of a speaker's sub-phonemes and provides enhanced adaptation of sub-phonemes in an existing model.

### HMM Models and Mapping

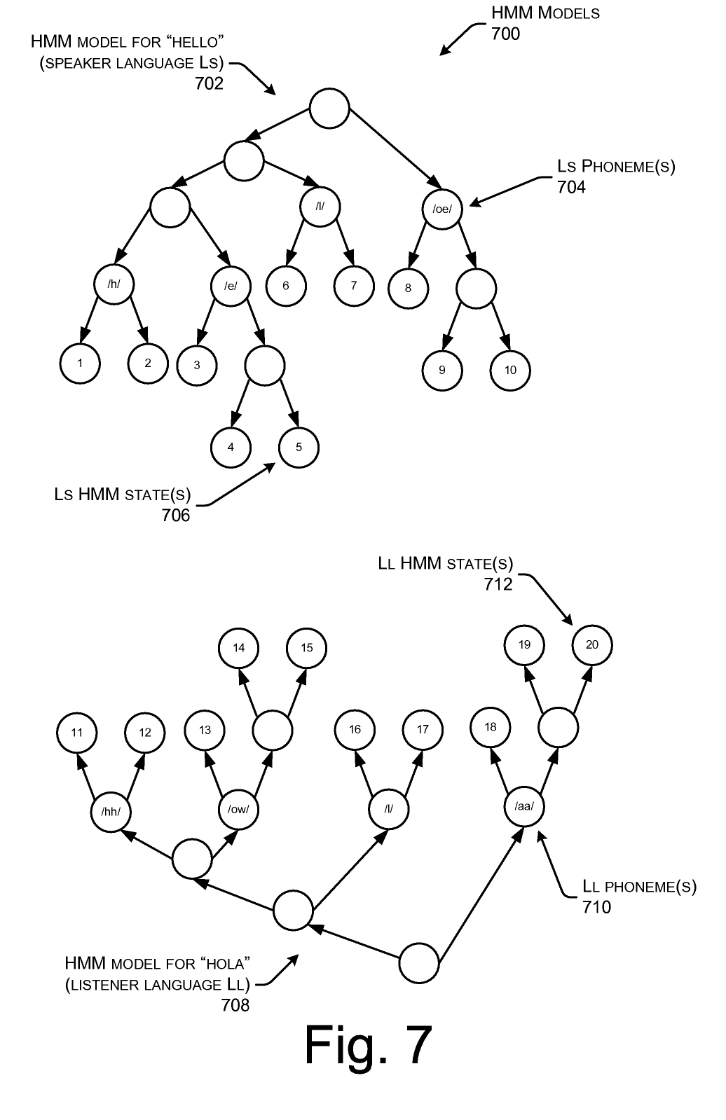

FIG. 7 is an illustration of HMM models for words in two different languages 700. A HMM model for the word “hello” of FIG. 2 in the language of the speaker (LS) is depicted as a hierarchal tree 702 with LS phoneme nodes 704 as described in FIG. 2 at 204(A) and their sub-phonemic LS HMM states 706 as described in FIG. 3 at 304 as leaves. The leaves are numbered 1-10.

Similarly, a HMM model for the word “hola” in the language of the listener's (LL) 708 is depicted showing LL phoneme nodes 710 and LL HMM state leaves 712. The leaves are numbered 11-20.

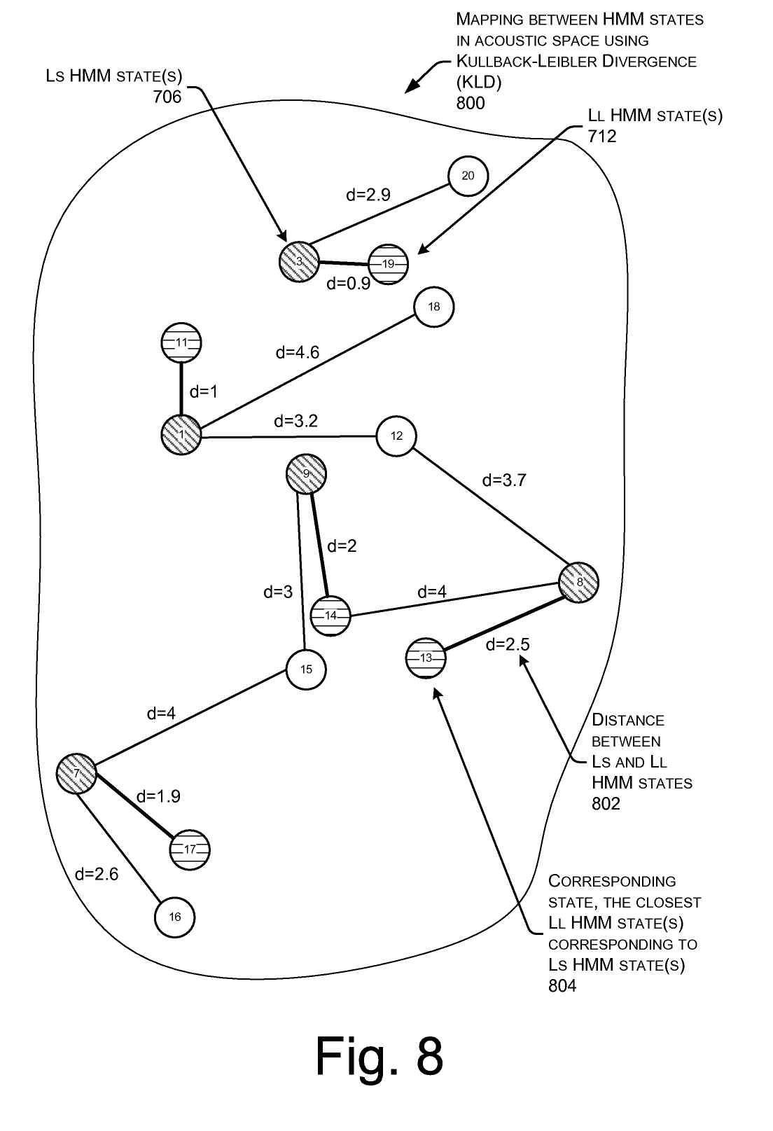

FIG. 8 is an illustration of mapping between the HMM states of the HMM models of FIG. 7 in acoustic space using KLD 800. This KLD mapping may be made using a distance between HMM states in acoustic space. Other distances may be used, for example, Euclidean distance, Mahalanobis distance, etc.

Mapping between states is described by the following equation:

$${\hat{S}}^{X} = {arg min}_{{S}^{X}} D ( {S}^{X} , {S}_{j}^{Y} ) \qquad ( 1 )$$

where, Sⱼ^{Y} is a state in language Y and Sⱼ^{X} is a state in language X and D is the distance between two states in an acoustic space.

When using KLD to determine distance, the asymmetric Kullback-Leibler divergence (AKLD) between two distributions p and q can be defined as:

$${D}_{KL} ( p ‖ q ) = \int p ( x ) log \frac{p ( x )}{q ( x )} d x \qquad ( 2 )$$

The symmetric version (SKLD) may be defined as:

J(p,q)=D_{KL}(p∥q)+D_{KL}(q∥p) (3)

While AKLD and SKLD are useful for pitch-type speech sounds, multi-space probability distribution (MSD) is useful in non-pitch or voiceless speech sounds. In MSD, the whole sample space Ω can be divided by G subspaces with index g.

$$Ω = {{⋃}^{G}}_{g = 1} {Ω}_{g} \qquad ( 4 )$$

Each space Ω_{g} has its probability ω_{g}, where:

$${\sum }_{g = 1}^{G} {ω}_{g} = 1 \qquad ( 5 )$$

Hence, the probability density function of MSD can be written as:

$$\begin{matrix}p ( x ) = {\sum }_{g = 1}^{G} {p}_{{Ω}_{g}} ( x ) = {\sum }_{g = 1}^{G} {ω}_{g} {M}_{g} ( x ) \\ where & ( 6 ) \\ {\int }_{{Ω}_{g}} {M}_{g} ( x ) d x = 1 & ( 7 )\end{matrix}$$

Equations (5), (6), and (7), may appear similar to multiple mixtures; however, they are not the same. In the mixture condition, distributions of components are overlapped while in MSD they are not. Hence, in MSD, we will have,

M_{g}(x)=0 ∀x∉Ω_{g} (8)

This property aids in calculating the distance between two distributions by [INVENTORS—why does this aid the calculation of the distance?].

Putting equations (6) into (2) which describes AKLD, the KLD with MSD can be found using Equation (9) below:

$$\begin{matrix}{D}_{KL} ( p ‖ q ) = {\int }_{Ω} p ( x ) log ( \frac{p ( x )}{q ( x )} ) d x \\ = {\int }_{Ω} {\sum }_{g = 1}^{G} {ω}_{g}^{p} {M}_{g}^{p} ( x ) log ( \frac{{\sum }_{g = 1}^{G} {ω}_{g}^{p} {M}_{g}^{p} ( x )}{{\sum }_{g = 1}^{G} {ω}_{g}^{q} {M}_{g}^{q} ( x )} ) d x \\ = {\sum }_{g = 1}^{G} \{ {\int }_{{Ω}_{g}} {\sum }_{g = 1}^{G} {ω}_{g}^{p} {M}_{g}^{p} ( x ) log ( \frac{{\sum }_{g = 1}^{G} {ω}_{g}^{p} {M}_{g}^{p} ( x )}{{\sum }_{g = 1}^{G} {ω}_{g}^{q} {M}_{g}^{q} ( x )} ) d x \}\end{matrix} \qquad ( 9 )$$

Putting equation (8) into equation (9), we will get equation (10). From equation 10, we can find that if the KLD of each sub-space has close form, the KLD of the multi-spaced distribution will also have the close form.

$$\begin{matrix}{D}_{KL} ( p ‖ q ) == {\sum }_{g = 1}^{G} \{ {\int }_{{Ω}_{g}} {\sum }_{g = 1}^{G} {ω}_{g}^{p} {M}_{g}^{p} ( x ) log ( \frac{{\sum }_{g = 1}^{G} {ω}_{g}^{p} {M}_{g}^{p} ( x )}{{\sum }_{g = 1}^{G} {ω}_{g}^{q} {M}_{g}^{q} ( x )} ) d x \} \\ = {\sum }_{g = 1}^{G} \{ {\int }_{{Ω}_{g}} {ω}_{g}^{p} {M}_{g}^{p} ( x ) log ( \frac{{ω}_{g}^{p} {M}_{g}^{p} ( x )}{{ω}_{g}^{q} {M}_{g}^{q} ( x )} ) d x \} \\ = {\sum }_{g = 1}^{G} \{ {ω}_{g}^{p} log ( \frac{{ω}_{g}^{p}}{{ω}_{g}^{q}} ) + {ω}_{g}^{p} {\int }_{{Ω}_{g}} {M}_{g}^{p} ( x ) log ( \frac{{M}_{g}^{p} ( x )}{{M}_{g}^{q} ( x )} ) d x \} \\ = {\sum }_{g = 1}^{G} \{ {ω}_{g}^{p} {D}_{KL} ( {M}_{g}^{p} ‖ {M}_{g}^{q} ) \} + {\sum }_{g = 1}^{G} \{ {ω}_{g}^{p} log ( \frac{{ω}_{g}^{p}}{{ω}_{g}^{q}} ) \}\end{matrix} \qquad ( 10 )$$

From this equation, the KLD with MSD has two terms; one is the weighted sum of KLD of each subspace; the other is the KLD of the weight distribution. The SKLD may also be used as well, with corresponding changes in the equations.

Given two HMMs, their KLD is defined as:

$${D}_{KL} ( p ‖ q ) = \int p ( {o}^{1 : t} ) log \frac{p ( {o}^{1 : t} )}{q ( {o}^{1 : t} )} d {o}^{1 : t} \qquad ( 11 )$$

where o^{1:t} is the observation sequence running from time 1 to t.

General calculation of Euclidean and Mahalanobis distances are readily known and thus not described herein. FIG. 8 depicts the distances between HMM states in acoustic space 800, using KLD and MSD in this illustration. For clarity, only some distances are calculated and shown. The distance 802 between LS HMM states 706 and LL HMM states 712 are depicted. LS HMM states 706 are depicted having angled hatching while corresponding LL HMM states 804 are shown with horizontal hatching. A corresponding LL HMM state is one which is closest to the LS HMM state in acoustic space. For example, LS HMM state 9 is shown with a distance of 2 to LL HMM state 14 and a distance of 3 to LL HMM state 15. LL HMM state 14 is closer (2<3) and thus is the corresponding state to LS HMM state 9. A map may be constructed using the corresponding states. A table of the mappings shown in FIG. 8 follows:

TABLE 1

| | mapped to |
|---|---|
| | corresponding |
| LS HMM state | LL HMM state |
| 1 | 11 |
| 3 | 19 |
| 7 | 17 |
| 8 | 13 |
| 9 | 14 |

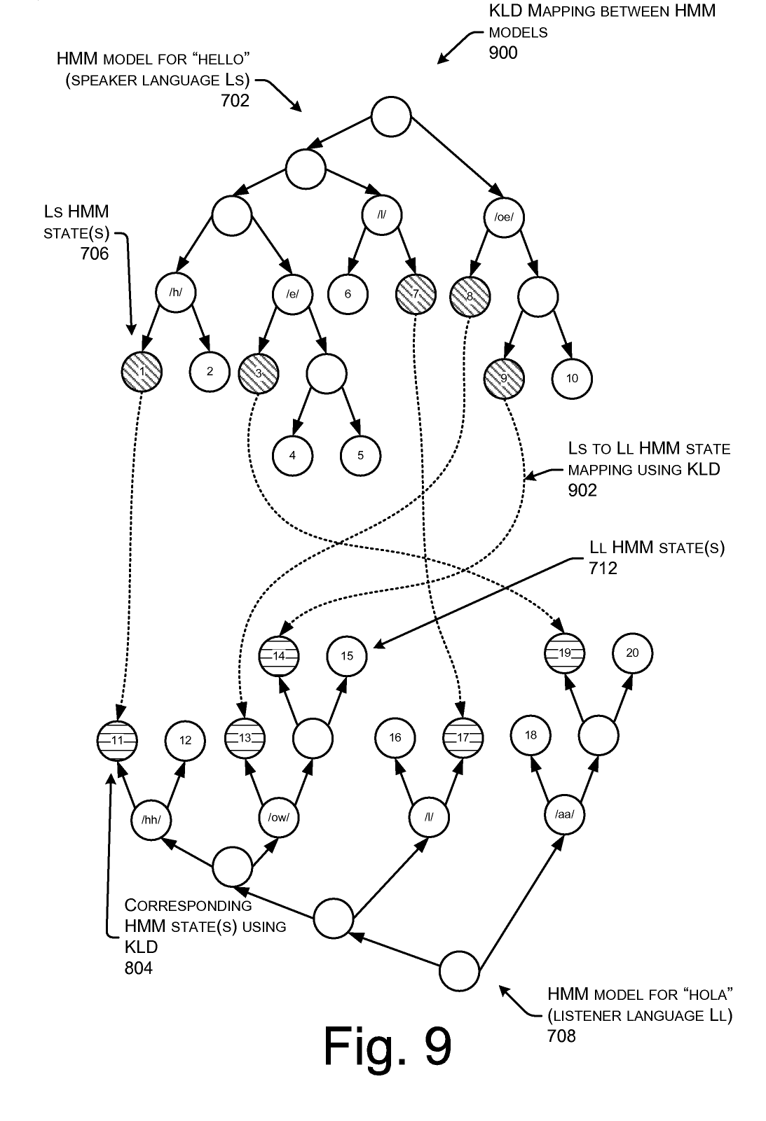

FIG. 9 is an illustration of KLD mapping 900 between the HMM states of the HMM models of FIG. 7, and illustrates Table 1 in the HMM model view. Because the HMM states are for sub-phonemes, the mapping is more comprehensive than if phonemes alone were used. For example, the /h/ phoneme in English does not directly map to the /hh/ phoneme in Spanish. However, by using sub-phonemic HMM states, a sub-phonemic mapping has been made between HMM state 1 and HMM state 11.

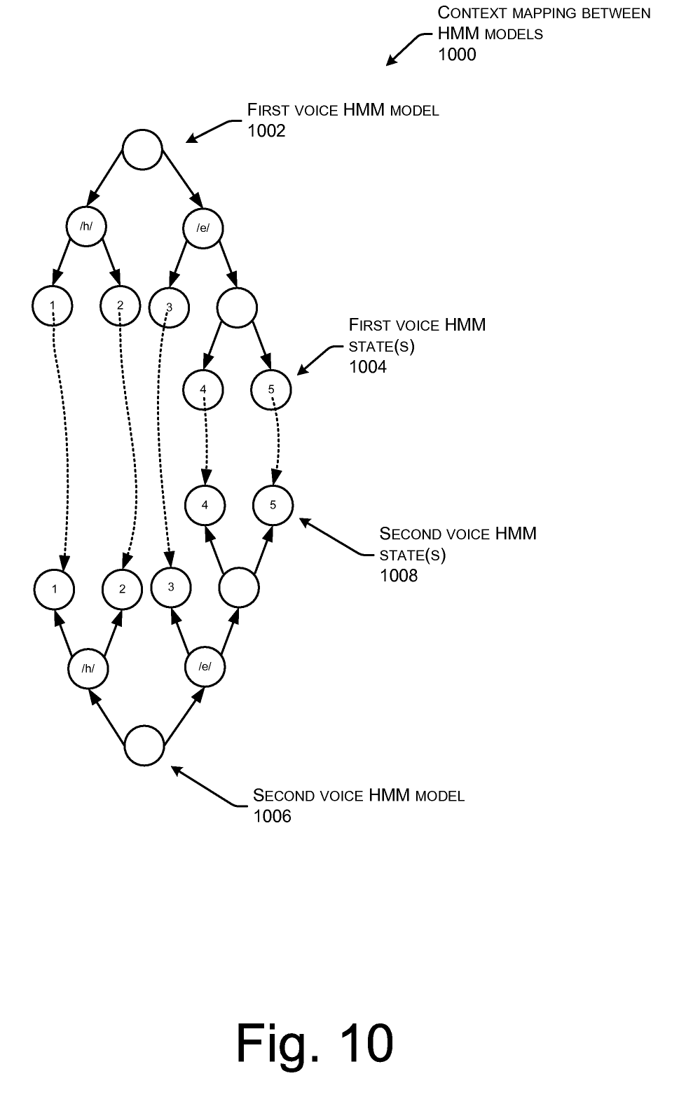

FIG. 10 is an illustration of context mapping between HMM states 1000. Context mapping occurs in the simpler case where the same language is being spoken by different voices. A first voice HMM model 1002 is shown having phoneme nodes and sub-phoneme HMM state leaves 1004 numbered 1-5. A matching second voice HMM model 1006 is shown with second voice HMM state leaves 1008 numbered 1-5 also. With context mapping, each leaf is mapped in a first model is mapped to the leaf having the same position, or context, in the hierarchy of the second model.

### Illustrative Computer System and Process

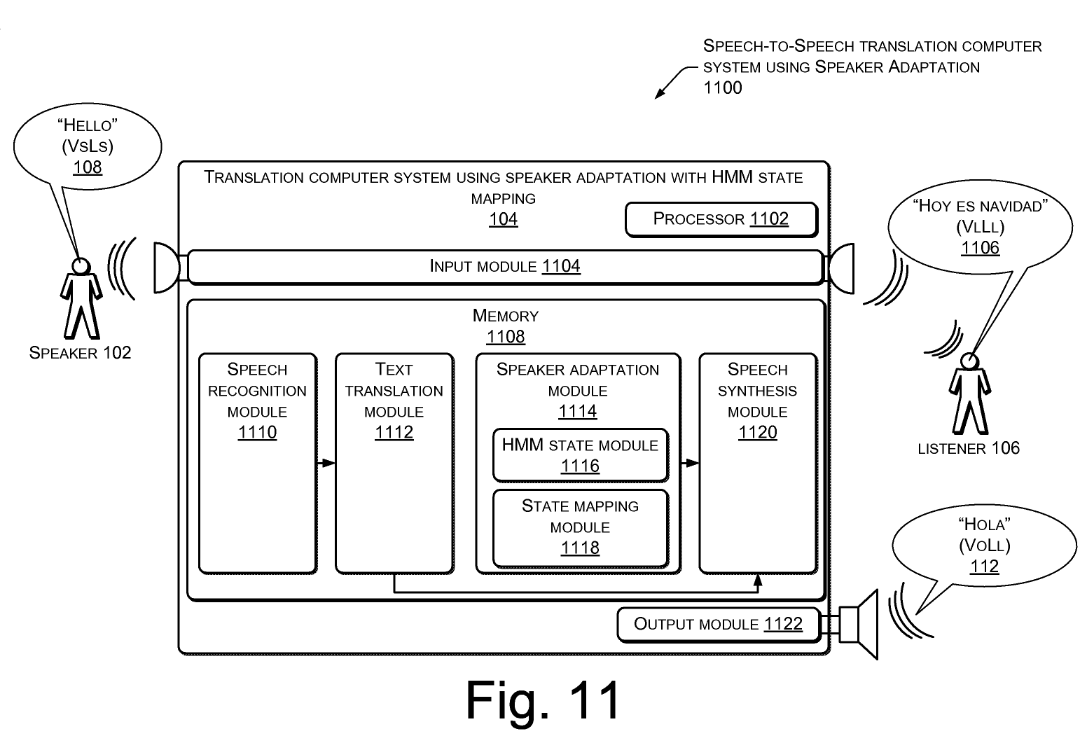

FIG. 11 is an illustrative schematic of a speech-to-speech translation computer system using speaker adaptation 1100. Shown is the translation computer system using speaker adaptation with HMM state mapping 104. Within the translation computer system 104 is a processor 1102. A human speaker 102 utters the word “hello” 108 or other input which is received an input device such as a microphone coupled to an input module 1104 coupled to processor 1102. The input module 1104 may also receive input 1106 from a listener 106, that is, the voice of the listener speaking the language of the listener (VLLL). Input module 1104 may receive input from other devices, for example stored sound files or streaming audio. Furthermore, input module 1104 may be present in another device.

Memory 1106 also resides within or is accessible by the translation computer system and comprises a computer readable storage medium and coupled to processor 1102. Memory 1108 also stores or has access to a speech recognition module 1110, a text translation module 1112, a speaker adaptation module 1114 further comprising an HMM state module 1116 and state mapping module 1118, and a speech synthesis module 1120. Each of these modules is configured to execute on processor 1102.

Speech recognition module 1110 is configured to receive spoken words and convert them to text in the speaker's language (TLS). Text translation module 1112 is configured to translate TLS into text of the language of the listener (TLL). Speaker adaptation module 1114 is configured to generate HMM state models in the HMM state module 1116 and map the HMM states in the state mapping module 1118. The state mapping module 1118 maps HMM states between HMM models using context or KLD mapping as previously described. Speech synthesis module 1120 receives the TLL from the text translation module 1112 and the speaker adaptation data from the speaker adaptation module 1114 to generate voice output in the language of the listener (VOLL). The voice output may be presented to listener 106 via output module 1122 which is coupled to processor 1102 and memory 1108. Output module 1122 may comprise a speaker to generate sound 112, generate output sound files for storage or transmission. Output module 1122 may also present in another device.

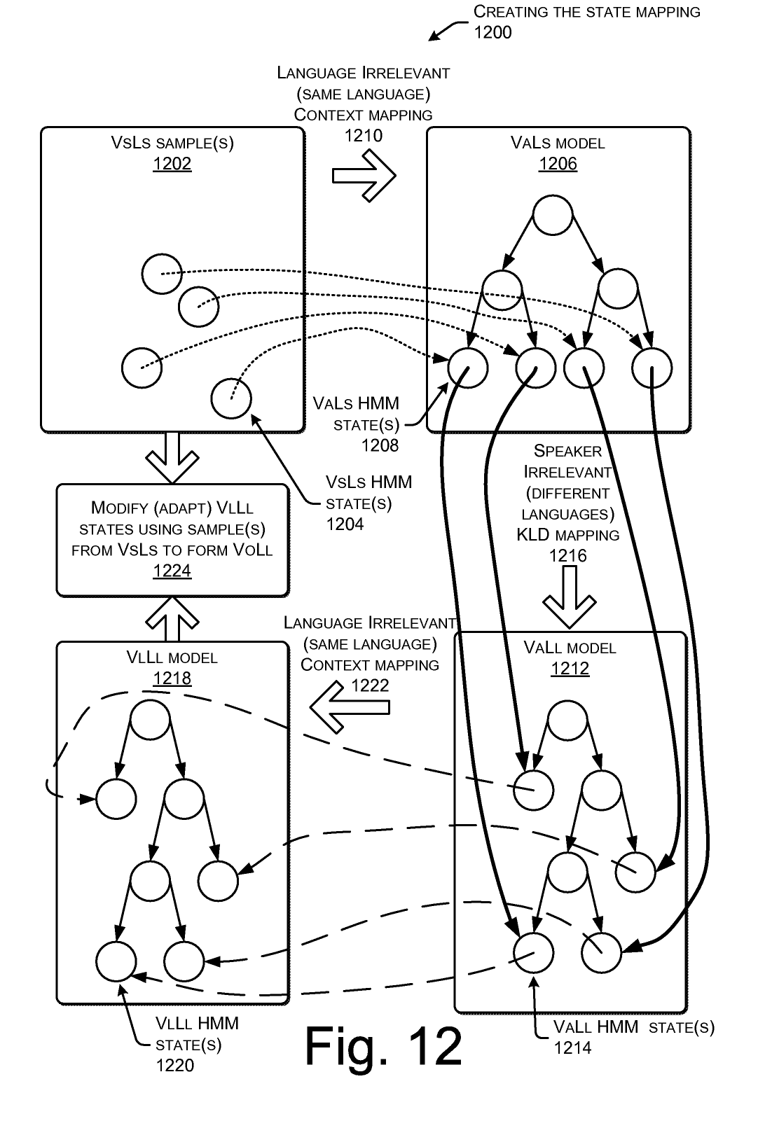

FIG. 12 is a flow diagram of an illustrative process of creating state mappings for cross-language speaker adaptation 1200. At 1202, samples of HMM states 1204 from a voice of a speaker speaking the language of the speaker (VSLS) are stored. At 1206, a HMM model of the voice of an auxiliary speaker speaking the language of the speaker (VALS) is shown with VALS HMM states 1208. An auxiliary speaker is a speaker who speaks both the languages of the speaker and listener. An average voice model may be used alone or in conjunction with an auxiliary speaker. At 1210, a language irrelevant (same language, different speakers) context mapping between the VSLS HMM states and the VALS HMM states is made. Context mapping is appropriate in this instance because the language is the same.

At 1212, a HMM model of the voice of the auxiliary speaker speaking the language of the listener (VALL) is shown with VALL HMM states 1214. At 1216, a speaker irrelevant (different languages, same speaker) KLD mapping between the VALS states and the VALL states is made, with HMM states being mapped to those HMM states closest in acoustic space as described above.

At 1218, a HMM model of the voice of the listener speaking the language of the listener (VLLL) is shown with VLLL HMM states 1220. At 1222, a language irrelevant context mapping between VALL HMM states and VLLL HMM states, similar to that describe above with respect to 1210.

At 1224, HMM states in the VLLL model are modified (or adapted) using samples from VSLS to form VOLL, which is then output.

As depicted in FIG. 12, the auxiliary speaker VA acts as a bridge between the languages with different HMM states (that is, different sub-phonemes), while the output VOLL comprises the HMM states generated through speaker adaptation using the voice of the speaker (VS) and the voice of the listener (VL), as adapted to make the output VOsimilar to the voice of the speaker (VS).

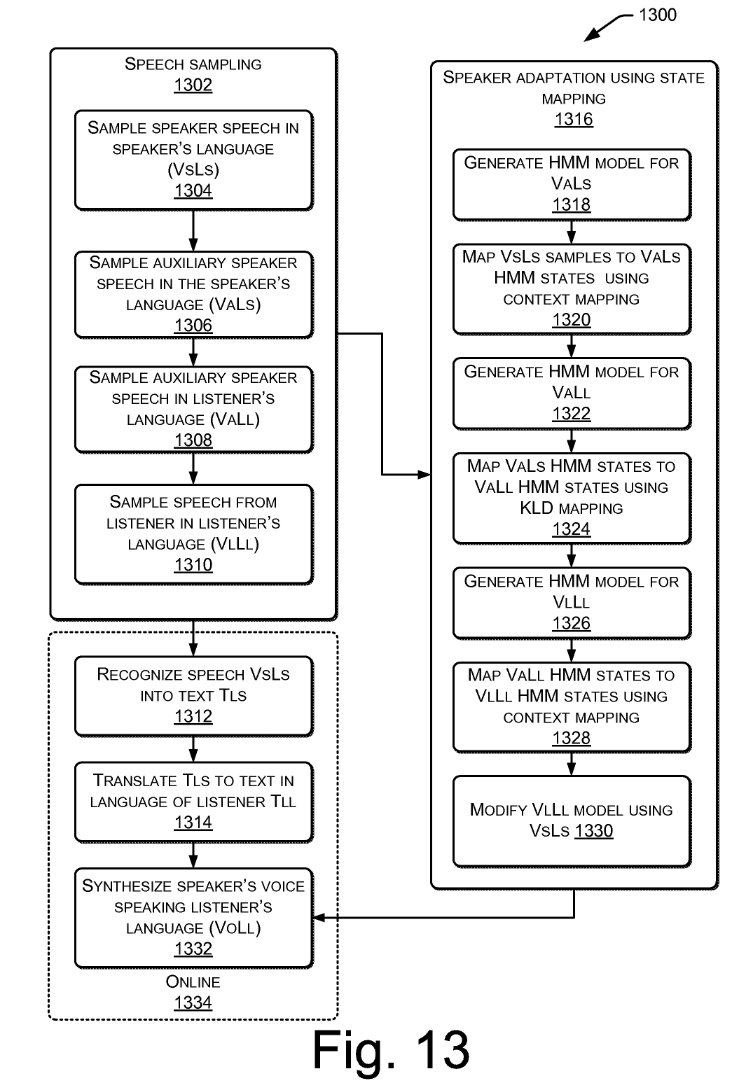

FIG. 13 is flow diagram of an illustrative process of state mapping for cross-language speaker adaptation 1300. At 1302, speech sampling takes place. At 1304, VSLS is sampled. At 1306, VALS is sampled. At 1306, VALL is sampled. At 1310, VLLL is sampled.

At 1312, VSLS is recognized into text in the language of the speaker (TLS). For example, speech recognition converts the spoken speech into text data. At 1314, TLS is translated into text in the language of the listener (TLL).

At 1316, speaker adaptation using state mapping takes place. At 1318, a HMM model is generated for VALS. At 1320, VSLS samples are mapped to VALS HMM states using context mapping. At 1322, a HMM model for VALL is generated. At 1324, VALS HMM states are mapped to VALL HMM states using KLD mapping. At 1326, a HMM model for VLLL is generated. At 1328, VALL HMM states are mapped to VLLL HMM states using context mapping. At 1330, the VLLL HMM model is modified using VSLS.

At 1332, the speaker's voice speaking the listener's language is synthesized (VOLL) using the TLL and VLLL model of 1330 which was modified by VSLS. Additionally, blocks 1312, 1314, and 1332 may be performed online, i.e. at the time of use, while the remaining blocks may be performed offline, i.e. at a time separate from speaker adaptation or in combinations of online and offline.

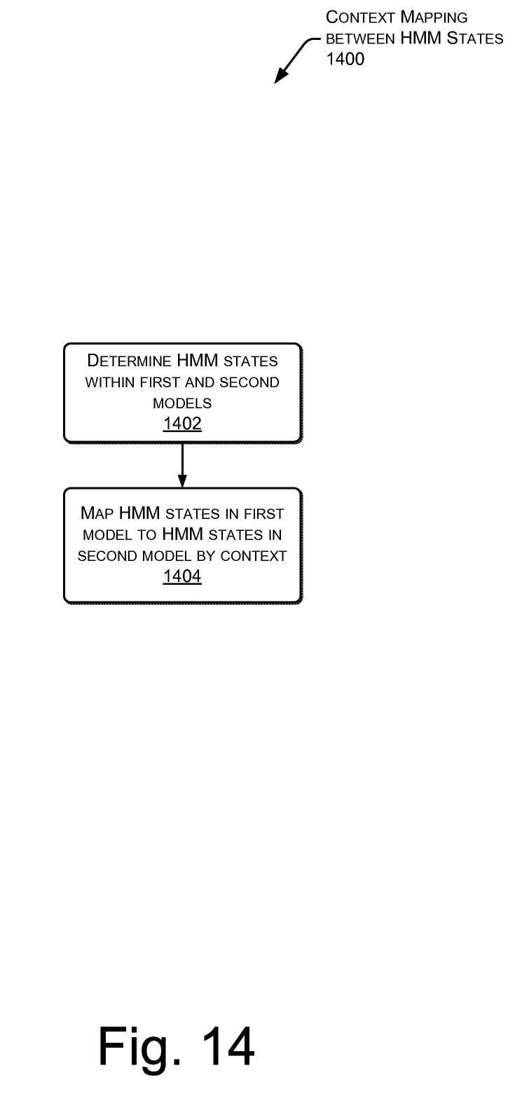

FIG. 14 is flow diagram of an illustrative process of context mapping between HMM states 1400. At 1402, HMM states within first and second HMM models are determined. At 1404, HMM states (leaves) in the first model are mapped to corresponding HMM states (leaves) in the second model having the same position in the hierarchy, or context.

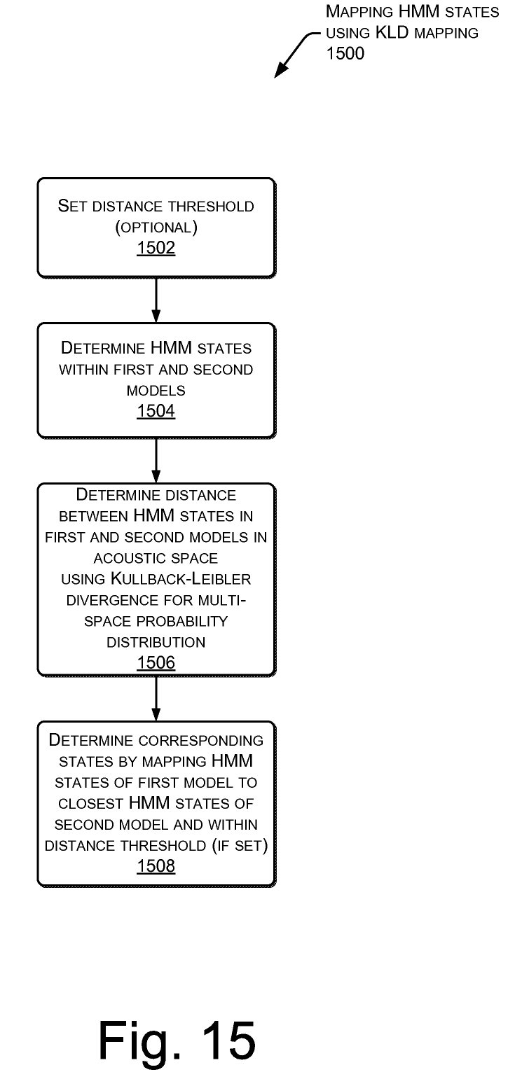

FIG. 15 is flow diagram of an illustrative process of KLD mapping between HMM states 1500. At 1502, an optional distance threshold may be set. This distance threshold may be used to improve quality in situations where the HMM states between languages diverge so much that such a distant mapping would result in undesirable output.

At 1504, HMM states within first and second HMM models are determined. At 1506, the distance in acoustic space between HMM states in the first and second HMM models is determined using KLD with MSD.

At 1508, corresponding states between the models are determined by mapping HMM states of the first model to the closest HMM states of the second model which are within the distance threshold (if set).

### CONCLUSION

Although specific details of illustrative processes are described with regard to the figures and other flow diagrams presented herein, it should be understood that certain acts shown in the figures need not be performed in the order described, and may be modified, and/or may be omitted entirely, depending on the circumstances. As described in this application, modules and engines may be implemented using software, hardware, firmware, or a combination of these. Moreover, the acts and processes described may be implemented by a computer, processor or other computing device based on instructions stored on memory, the memory comprising one or more computer-readable storage media (CRSM).

The CRSM may be any available physical media accessible by a computing device to implement the instructions stored thereon. CRSM may include, but is not limited to, random access memory (RAM), read-only memory (ROM), electrically erasable programmable read-only memory (EEPROM), flash memory or other solid-state memory technology, compact disk read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by a computing device.

What is claimed is:

1. One or more computer-readable storage media storing instructions for cross-language speaker adaptation in speech-to-speech language translation that when executed instruct a processor to perform acts comprising:
sampling a source speaker's voice in a speaker's language (VSLS);
sampling an auxiliary speaker's voice in the source speaker's language (VALS);
sampling the auxiliary speaker's voice in a listener's language (VALL);
sampling a listener's voice in the listener's language (VLLL);
recognizing VSLS into text of the source speaker's language (TLS);
translating the TLS to text of the listener's language (TLL);
generating a Hidden Markov Model (HMM) model for the VALS;
mapping VSLS samples to VALS HMM states using context mapping;
generating a HMM model for the VALL;
mapping VALS HMM model states to VALL HMM model states, wherein the HMM states of the VALS model are mapped to the HMM states of the VALL model which are closest in an acoustic space using distortion measure mapping;
generating a HMM model for the VLLL;
mapping states of the VALL HMM model to states of the VLLL HMM model using context mapping; and
modifying VLLL using the VSLS samples to form a source speaker's voice speaking the listener's language (VOLL).

2. The computer-readable storage media of claim 1, wherein each HMM state represents a distinctive sub-phonemic acoustic-phonetic event.

3. The computer-readable storage media of claim 1, wherein context mapping comprises determining the HMM states within a first HMM model and a second HMM model to be context mapped; and mapping HMM states in the first model to HMM states in the second model which have a corresponding context in the second HMM model.

4. The computer-readable storage media of claim 1, wherein distortion measure mapping further comprises setting a distance threshold and disallowing mappings exceeding the distance threshold.

5. The computer-readable storage media of claim 1, wherein the closest states in the distortion measure mapping are determined by:
$${\hat{S}}^{X} = {arg min}_{{S}^{X}} D ( {S}^{X} , {S}_{j}^{Y} )$$
where, Sⱼ^{Y} is a state in language Y and Sⱼ^{X} is a state in language X and D is the distance between two states.

6. The computer-readable storage media of claim 1, wherein the closest states in the distortion measure mapping are determined by:
$${\hat{S}}^{X} = {arg min}_{{S}^{X}} D ( {S}^{X} , {S}_{j}^{Y} )$$
where, Sⱼ^{Y} is a state in language Y and Sⱼ^{X} is a state in language X and D is the distance between two states, wherein D is calculated by a Kullback-Leibler Divergence (KLD) with multi-space probability distribution (MSD):
$$\begin{matrix}{D}_{KL} ( p ‖ q ) = {\int }_{Ω} p ( x ) log ( \frac{p ( x )}{q ( x )} ) d x \\ = {\sum }_{g = 1}^{G} \{ {\int }_{{Ω}_{g}} {ω}_{g}^{p} {M}_{g}^{p} ( x ) log ( \frac{{ω}_{g}^{p} {M}_{g}^{p} ( x )}{{ω}_{g}^{q} {M}_{g}^{q} ( x )} ) d x \} \\ = {\sum }_{g = 1}^{G} \{ {ω}_{g}^{p} log ( \frac{{ω}_{g}^{p}}{{ω}_{g}^{q}} ) + {ω}_{g}^{p} {\int }_{{Ω}_{g}} {M}_{g}^{p} ( x ) log ( \frac{{M}_{g}^{p} ( x )}{{M}_{g}^{q} ( x )} ) d x \} \\ = {\sum }_{g = 1}^{G} \{ {ω}_{g}^{p} {D}_{KL} ( {M}_{g}^{p} ‖ {M}_{g}^{q} ) \} + {\sum }_{g = 1}^{G} \{ {ω}_{g}^{p} log ( \frac{{ω}_{g}^{p}}{{ω}_{g}^{q}} ) \}\end{matrix}$$
where p and q are distributions, and the whole sample space may be divided by G subspaces with index g.

7. A method comprising:
sampling first speech from a speaker in a first language (VALS);
decomposing the first speech into first speech sub-phoneme samples;
generating a Hidden Markov Model (HMM) model of the VALS comprising HMM states, wherein each state represents a distinctive sub-phonemic acoustic-phonetic event derived from the first speech sub-phoneme samples;
training the first state model VALS using the sub-phoneme samples;
sampling second speech from the speaker in a second language (VALL);
decomposing the second speech into first speech sub-phoneme samples;
generating a Hidden Markov Model (HMM) model of the VALL comprising HMM states, wherein each state represents a distinctive sub-phonemic acoustic-phonetic event derived from the second speech sub-phoneme samples;
training the second state model VALL using the sub-phoneme samples; and
determining corresponding states between VALS HMM model states and VALL HMM model states using Kullback-Leibler Divergence with multi-space probability distribution (KLD).

8. The method of claim 7, wherein the corresponding states are determined by:
$${\hat{S}}^{X} = {arg min}_{{S}^{X}} D ( {S}^{X} , {S}_{j}^{Y} )$$
where, Sⱼ^{Y} is a state in language Y and Sⱼ^{X} is a state in language X and D is the distance between two states in acoustic space, wherein D is calculated by KLD and MSD of the form:
$$\begin{matrix}{D}_{KL} ( p ‖ q ) = {\int }_{Ω} p ( x ) log ( \frac{p ( x )}{q ( x )} ) d x \\ = {\sum }_{g = 1}^{G} \{ {\int }_{{Ω}_{g}} {ω}_{g}^{p} {M}_{g}^{p} ( x ) log ( \frac{{ω}_{g}^{p} {M}_{g}^{p} ( x )}{{ω}_{g}^{q} {M}_{g}^{q} ( x )} ) d x \} \\ = {\sum }_{g = 1}^{G} \{ {ω}_{g}^{p} log ( \frac{{ω}_{g}^{p}}{{ω}_{g}^{q}} ) + {ω}_{g}^{p} {\int }_{{Ω}_{g}} {M}_{g}^{p} ( x ) log ( \frac{{M}_{g}^{p} ( x )}{{M}_{g}^{q} ( x )} ) d x \} \\ = {\sum }_{g = 1}^{G} \{ {ω}_{g}^{p} {D}_{KL} ( {M}_{g}^{p} ‖ {M}_{g}^{q} ) \} + {\sum }_{g = 1}^{G} \{ {ω}_{g}^{p} log ( \frac{{ω}_{g}^{p}}{{ω}_{g}^{q}} ) \}\end{matrix}$$
where p and q are distributions, and the whole sample space may be divided by G subspaces with index g.

9. The method of claim 7, further comprising mapping corresponding states of the VALS HMM model to the VALL HMM model.

10. The method of claim 7, further comprising determining a similarity between VALS HMM model states and VALL HMM model states based on a distance between the VALS HMM states and VALL HMM states in an acoustic space defined by the KLD.

11. The method of claim 7, wherein training the first state model VALS using the sub-phoneme samples comprises taking a plurality of sub-phoneme samples for the same sub-phoneme and building a state.

12. The method of claim 7, further comprising:
sampling speech from a source speaker speaking the language of the source speaker (VSLS) and generating HMM states VSLS;
sampling a listener's speech in the listener's language (VLLL);
recognizing speech VSLS into text of the source speaker's language (TLS);
translating the TLS into text of the language of the listener (TLL);
mapping VSLS samples to VALS HMM states using context mapping;
generating a HMM model for the VLLL;
mapping states of the VALL HMM model to states of the VLLL HMM model using context mapping; and
modifying VLLL using the samples of VSLS using the mappings to form source speaker's voice speaking the listener's language (VOLL).

13. The method of claim 12, wherein context mapping comprises mapping a first HMM state in a first HMM model to a second HMM state in a second HMM model where the first HMM state has the same context as the second HMM state.

14. The method of claim 12, further comprising synthesizing the source speaker's voice speaking TLL in the listener's language (VOLL).

15. A system of speech-to-speech translation with cross-language speaker adaptation, the system comprising:
a processor;
a memory coupled to the processor;
a speaker adaptation module, stored in memory and configured to execute on the processor, the speaker adaptation module configured to map a first Hidden Markov Model (HMM) model of speech in a first language to a second HMM model of speech in a second language using Kullback-Leibler Divergence (KLD) with multi-space probability distribution (MSD).

16. The system of claim 15, wherein the HMM models further comprise HMM states, where each state in the HMM represents a distinctive sub-phonemic acoustic-phonetic event.

17. The system of claim 16, wherein the speaker adaptation module is further configured to determine a distance between HMM states in the first HMM model and the second HMM model.

18. The system of claim 17, further comprising a distance threshold configured in the speaker adaptation module and mapping HMM states in the speaker adaptation module from the first HMM model with HMM states from the second HMM model which are within the distance threshold.

19. The system of claim 15, further comprising:
an input module coupled to the processor and memory;
an output module coupled to the processor and memory;
a speech recognition module stored in memory and configured to execute on the processor, the speech recognition module configured to receive the first speech from the input module and recognize the first speech to form text in the first language;
a text translation module stored in memory and configured to execute on the processor, the text translation module configured to translate text from the first language to the second language; and
a speech synthesis module stored in memory and configured to execute on the processor, the speech synthesis module configured to generate synthesized speech from the translated text in the second language for output through the output module.

20. The system of claim 19, wherein the speech recognition module, text translation module, and speech synthesis module are in operation and available for use while the remaining modules are unavailable.
